(19) United States
(12) Patent Application Publication
(10) Pub. No.: US 2010/0271844 A1
(43) Pub. Date: Oct. 28, 2010

(54) LIGHT-GUIDING STRUCTURE WITH PHOSPHOR MATERIAL LAYERS

(75) Inventors: Bily Wang, Hsinchu City (TW); Jonnie Chuang, Banciao City (TW)

Correspondence Address: KILE PARK REED & MCMANUS, 1200 NEW HAMPSHIRE AVE, NW, SUITE 570, WASHINGTON, DC, 20036, US

(73) Assignee: HARVATEK CORPORATION

(21) Appl. No.: 12/429,469

(22) Filed: Apr. 24, 2009

(51) Int. Cl. F21V 7/22

(52) U.S. Cl. 362/629

(57) ABSTRACT

A light-guiding structure with phosphor material layers includes a light-guiding unit, a light-emitting unit and a phosphor unit. The light-emitting unit is disposed beside an outer lateral side of the light-guiding unit. The phosphor unit is connected with the light-guiding unit and is disposed between the light-guiding unit and the light-emitting unit. In addition, the phosphor unit is formed or pasted on the lateral side of the light-guiding unit, and the light-emitting unit has a PCB substrate and a plurality of light-emitting elements electrically disposed on the PCB substrate and facing the light-guiding unit. Hence, light beams generated by the light-emitting elements of the light-emitting unit pass through the phosphor unit to form another light beams, and the light beams are guided into the light-guiding unit. Finally, the light beams are projected out from a light-exiting face of the light-guiding unit.

### BACKGROUND OF THE INVENTION

1. Field of the Invention

The present invention relates to a light-guiding structure, and particularly relates to a light-guiding structure with phosphor material layers.

2. Description of Related Art

Among all kinds of flat display devices, a liquid crystal display (LCD) device with low electrical power consumption, low voltage operation, thinner thickness and lighter weight, is widely used in nowadays. A liquid crystal display device typically includes a first substrate having common electrodes and a color filter, and a second substrate having thin film transistors and pixel electrodes. The first substrate and the second substrate are provided substantially in parallel with a predetermined gap therebetween, and liquid crystal is injected between the two opposing substrates. An electric field is formed between the substrates by applying different voltages to the pixel electrodes and common electrodes. Accordingly, the alignment of liquid crystal molecules of the liquid crystal material is varied to thereby control the transmittance of incident light. The visions of liquid crystal display devices (LCD) are extremely excellent since the displayed figures or pictures are not offensive to the eyes of human being unlike light emitting diode (LED). But it is one of the drawbacks of LCD that an additional light module is needed in order to show figures or pictures on the screen under the dark circumstance because LCD does not have the character of light-emitting itself.

In general, a light module has a light-emitting device and a light-guiding board for guiding light beams generated by the light-emitting device. In addition, if the designer wants the light-emitting device to generate white light beams, many phosphor layers need to be respectively coated on the surface of each light-emitting element of the light-emitting device.

However, because many phosphor layers need to be respectively coated on the surface of each light-emitting element of the light-emitting device, the manufacturing cost and manufacturing time of the prior art would be increased.

### SUMMARY OF THE INVENTION

One particular aspect of the present invention is to provide a light-guiding structure with phosphor material layers that can reduce the manufacturing cost and manufacturing time.

In order to achieve the above-mentioned aspects, the present invention provides a light-guiding structure with phosphor material layers including: a light-guiding unit, a light-emitting unit and a phosphor unit. The light-emitting unit is disposed beside an outer lateral side of the light-guiding unit. The phosphor unit is connected with the light-guiding unit and is disposed between the light-guiding unit and the light-emitting unit.

Moreover, the present invention has the following combinations for light-guiding unit and the phosphor unit:

1. First embodiment: the phosphor unit is formed or pasted on a lateral side of the light-guiding unit.

2. Second embodiment: the light-guiding unit has a light-guiding body and an open-type groove formed on a lateral side of the light-guiding body, and the phosphor unit is received in the open-type groove of the light-guiding unit.

3. Third embodiment: the light-guiding unit has a light-guiding body and a close-type groove formed in the light-guiding body and close to a lateral side of the light-guiding body, and the phosphor unit is received in the close-type groove of the light-guiding unit.

4. Fourth embodiment: the light-guiding unit has a light-guiding body, an open-type groove formed on a lateral side of the light-guiding body and two retaining portions respectively formed on two opposite inner sides of the open-type groove, the phosphor unit is received in the open-type groove of the light-guiding unit, and two opposite ends of the phosphor unit is respectively restricted and fixed by the two retaining portions.

5. Fifth embodiment: the light-guiding structure further includes a clipping unit disposed beside a lateral side of the light-guiding unit in order to clip the phosphor unit, wherein the clipping unit has two retaining grooves for respectively retaining two opposite ends of the phosphor unit.

Therefore, each light-emitting element does not has any phosphor layer coated on its surface, so that the light-emitting elements of the present invention can mate with the phosphor unit that is disposed on the light-guiding board to generate white light beams without coating phosphor layer on the light-emitting elements in advance. Hence, the manufacturing cost and manufacturing time of the present invention can be recued. For example, each light-emitting element is blue LED and each blue LED does not has any phosphor layer coated on its surface. Hence, blue light beams generated by the blue LEDs can pass through the phosphor unit in order to form white light beams.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawings, in which:

FIG. 1A is a top, schematic view of a light-guiding structure with phosphor material layers according to the first embodiment of the present invention;

FIG. 1B is a lateral, schematic view of a light-guiding structure with phosphor material layers according to the first embodiment of the present invention;

FIG. 2A is a top, schematic view of a light-guiding structure with phosphor material layers according to the second embodiment of the present invention;

FIG. 2B is a lateral, schematic view of a light-guiding structure with phosphor material layers according to the second embodiment of the present invention;

FIG. 3 is a top, schematic view of a light-guiding unit mated with a phosphor unit according to the third embodiment of the present invention;

FIG. 4 is a top, schematic view of a light-guiding unit mated with a phosphor unit according to the fourth embodiment of the present invention;

FIG. 5 is a top, schematic view of a light-guiding unit mated with a phosphor unit according to the fifth embodiment of the present invention; and

FIG. 6 is a top, schematic view of a light-guiding unit mated with a phosphor unit according to the sixth embodiment of the present invention.

### DETAILED DESCRIPTION OF THE PREFERRED EMBODIMENTS

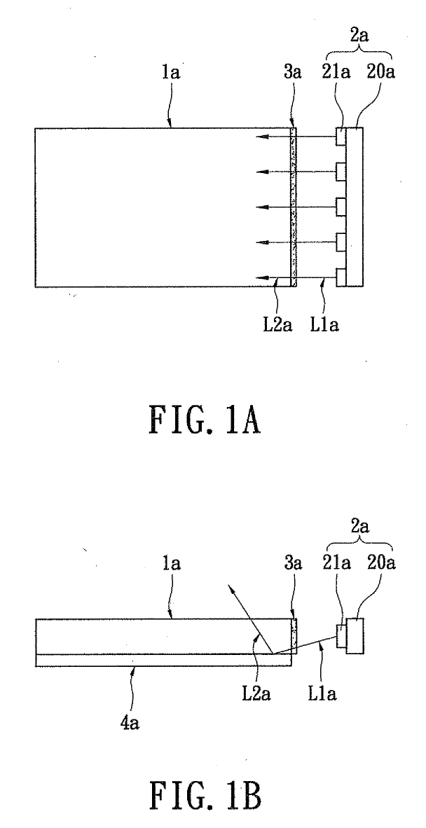

Referring to FIGS. 1A and 1B, the first embodiment of the present invention provides a light-guiding structure with phosphor material layers, including: a light-guiding unit 1a, a light-emitting unit 2a and a phosphor unit 3a.

The light-guiding unit 1a can be a light-guiding board in order to guide light beams from its one side to its another side. In addition, the light-emitting unit 2a is disposed beside an outer lateral side of the light-guiding unit 1a. The light-emitting unit 1a has a PCB substrate 20a and a plurality of light-emitting elements 21a electrically disposed on the PCB substrate 20a and facing the light-guiding unit 1a.

Moreover, the phosphor unit 3a can be a phosphor layer. The phosphor layer can be formed by mixing any different ingredients with any color. For example, according to different requirements, the phosphor layer is fluorescent resin that can be formed by mixing silicone and fluorescent powder or mixing epoxy and fluorescent powder.

Furthermore, the phosphor unit 3a is connected with the light-guiding unit 1a and is disposed between the light-guiding unit 1a and the light-emitting unit 2a. In the first embodiment, the phosphor unit 3a can be formed on a lateral side of the light-guiding unit 1a, such as coating, printing or spraying etc. In addition, the phosphor unit 3a also can be pasted on the lateral side of the light-guiding unit 1a. In other words, the phosphor unit 3a can be formed or pasted on the lateral side of the light-guiding unit 1a, and the lateral side is a light-entering face of the light-guiding unit 1a.

In addition, referring to FIG. 1B, the light-guiding structure of the first embodiment further includes: a reflecting unit 4a disposed under the light-guiding unit 1a. Hence, light beams L1a generated by the light-emitting elements 21a of the light-emitting unit 2a pass through the phosphor unit 3a to form another light beams L2a, and the light beams L2a are guided into the light-guiding unit 1a. Finally, the light beams L2a are projected out from a light-exiting face of the light-guiding unit 1a.

For example, each light-emitting element 21a is blue LED and each light-emitting element 21a does not has any phosphor layer coated on its surface. Hence, blue light beams generated by the light-emitting elements 21a (the blue LEDs) pass through the phosphor unit 3a to form white light beams. Therefore, the light-emitting elements 21a of the present invention can mate with the phosphor unit 3a to generate white light beams without coating phosphor layer on the light-emitting elements 21a in advance, so that the manufacturing cost and manufacturing time of the present invention can be recued.

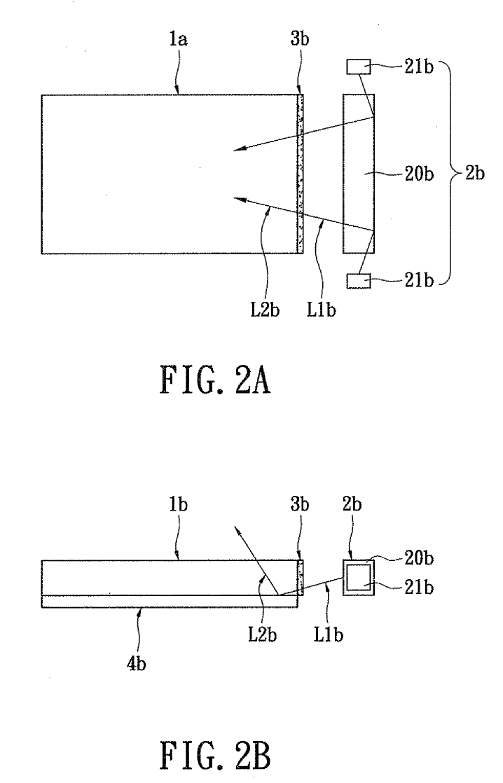

Referring to FIGS. 2A and 2B, the second embodiment of the present invention provides a light-guiding structure with phosphor material layers, including: a light-guiding unit 1b, a light-emitting unit 2b, a phosphor unit 3b and a reflecting unit 4b.

The difference between the second embodiment and the first embodiment is that: in the second embodiment, the light-emitting unit 2b has a light pipe 20b disposed beside a lateral side of the light-guiding unit 1b and at least one light-emitting element 21b disposed beside one end of the light pipe 20b (the second embodiment discloses two light-emitting elements 21b).

Hence, light beams L1b generated by the light-emitting elements 21b of the light-emitting unit 2b are guided and projected onto the phosphor unit 3b by the light pipe 20b, and then the light beams L1b pass through the phosphor unit 3b to form another light beams L2b, and then the light beams L2b are guided into the light-guiding unit 1b. Finally, the light beams L2b are projected out from a light-exiting face of the light-guiding unit 1b. For example, each light-emitting element 21b is blue LED and each light-emitting element 21b does not has any phosphor layer coated on its surface. Hence, blue light beams generated by the light-emitting elements 21b (the blue LEDs) are guided by the light pipe 20b and pass through the phosphor unit 3b to form white light beams. Therefore, the light-emitting elements 21b of the present invention can mate with the light pipe 20b and the phosphor unit 3b to generate white light beams without coating phosphor layer on the light-emitting elements 21b in advance, so that the manufacturing cost and manufacturing time of the present invention can be recued.

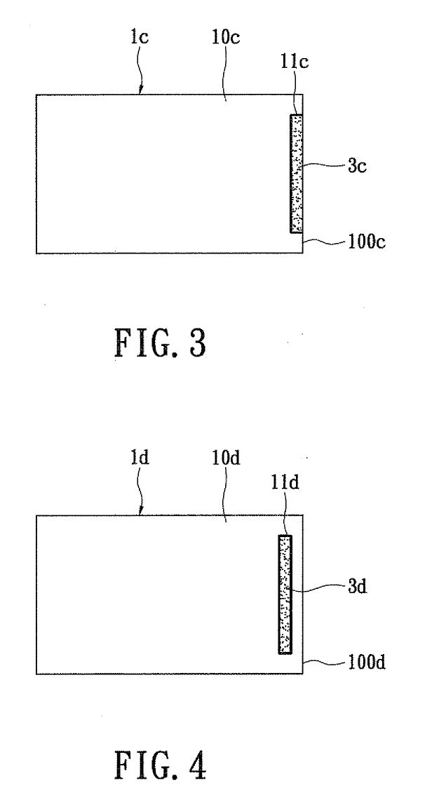

Referring to FIG. 3, the difference between the third embodiment and other embodiments is that: in the third embodiment, the light-guiding unit 1c has a light-guiding body 10c and an open-type groove 11c formed on a lateral side of the light-guiding body 10c (on a light-entering face 100c of the light-guiding body 10c), and the phosphor unit 3c is received in the open-type groove 11c of the light-guiding unit 1c.

Referring to FIG. 4, the difference between the fourth embodiment and other embodiments is that: in the fourth embodiment, the light-guiding unit 1d has a light-guiding body 10d and a close-type groove 11d formed in the light-guiding body 10d and close to a lateral side of the light-guiding body 10d (close to a light-entering face 100d of the light-guiding body 10d), and the phosphor unit 3d is received in the close-type groove 11d of the light-guiding unit 1d.

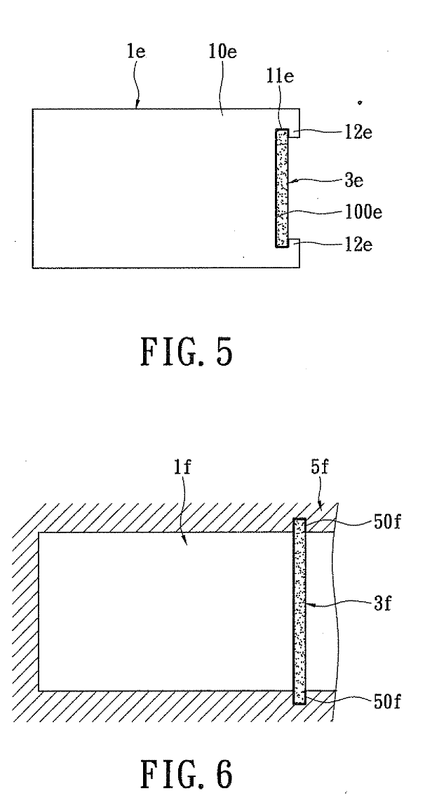

Referring to FIG. 5, the difference between the fifth embodiment and other embodiments is that: in the fifth embodiment, the light-guiding unit 1e has a light-guiding body 10e, an open-type groove 11e formed on a lateral side of the light-guiding body 10e (on a light-entering face 100e of the light-guiding body 10e) and two retaining portions 12e respectively formed on two opposite inner sides of the open-type groove 11e. In addition, the phosphor unit 3e is received in the open-type groove 11e of the light-guiding unit 1e, and two opposite ends of the phosphor unit 3e is respectively restricted and fixed by the two retaining portions 12e.

Referring to FIG. 6, the difference between the sixth embodiment and other embodiments is that: the sixth embodiment further includes a clipping unit 5f disposed beside a lateral side of the light-guiding unit if in order to clip the phosphor unit 3f. In addition, the clipping unit 5f has two retaining grooves 50f for respectively retaining two opposite ends of the phosphor unit 3f. For example, the clipping unit 5f can be a casing with a receiving groove in order to receive the light-guiding unit if, and the two retaining grooves 50f can be two concave grooves respectively formed on an inner wall of the casing.

In conclusion, each light-emitting element does not has any phosphor layer coated on its surface, so that the light-emitting elements of the present invention can mate with the phosphor unit that is disposed on the light-guiding board to generate white light beams without coating phosphor layer on the light-emitting elements in advance. Hence, the manufacturing cost and manufacturing time of the present invention can be recued. For example, each light-emitting element is blue LED and each blue LED does not has any phosphor layer coated on its surface. Hence, blue light beams generated by the blue LEDs can pass through the phosphor unit in order to form white light beams.

Although the present invention has been described with reference to the preferred best molds thereof it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. A light-guiding structure with phosphor material layers, comprising:
a light-guiding unit;
a light-emitting unit disposed beside an outer lateral side of the light-guiding unit; and
a phosphor unit connected with the light-guiding unit and disposed between the light-guiding unit and the light-emitting unit.

2. The light-guiding structure as claimed in claim 1, wherein the light-guiding unit is a light-guiding board.

3. The light-guiding structure as claimed in claim 1, wherein the phosphor unit is formed or pasted on a lateral side of the light-guiding unit.

4. The light-guiding structure as claimed in claim 1, wherein the light-guiding unit has a light-guiding body and an open-type groove formed on a lateral side of the light-guiding body, and the phosphor unit is received in the open-type groove of the light-guiding unit.

5. The light-guiding structure as claimed in claim 1, wherein the light-guiding unit has a light-guiding body and a close-type groove formed in the light-guiding body and close to a lateral side of the light-guiding body, and the phosphor unit is received in the close-type groove of the light-guiding unit.

6. The light-guiding structure as claimed in claim 1, wherein the light-guiding unit has a light-guiding body, an open-type groove formed on a lateral side of the light-guiding body and two retaining portions respectively formed on two opposite inner sides of the open-type groove, the phosphor unit is received in the open-type groove of the light-guiding unit, and two opposite ends of the phosphor unit is respectively restricted and fixed by the two retaining portions.

7. The light-guiding structure as claimed in claim 1, further comprising: a clipping unit disposed beside a lateral side of the light-guiding unit in order to clip the phosphor unit, wherein the clipping unit has two retaining grooves for respectively retaining two opposite ends of the phosphor unit.

8. The light-guiding structure as claimed in claim 1, wherein the phosphor unit is a phosphor layer.

9. The light-guiding structure as claimed in claim 1, wherein the light-emitting unit has a PCB substrate and a plurality of light-emitting elements electrically disposed on the PCB substrate and facing the light-guiding unit.

10. The light-guiding structure as claimed in claim 1, wherein the light-emitting unit has a light pipe disposed beside a lateral side of the light-guiding unit and at least one light-emitting element disposed beside one end of the light pipe.
